(19) United States
(12) Patent Application Publication
(10) Pub. No.: US 2025/0297916 A1
(43) Pub. Date: Sep. 25, 2025

(54) REFLECTIVE VEHICLE WARNING FIXTURE VERIFICATION DEVICE AND SYSTEM

(71) Applicant: Winston McIntosh, Wildwood, MO (US)

(72) Inventor: Winston McIntosh, Wildwood, MO (US)

(21) Appl. No.: 19/086,829

(22) Filed: Mar. 21, 2025

Related U.S. Application Data
(60) Provisional application No. 63/568,225, filed on Mar. 21, 2024.

(51) Int. Cl. G01M 11/02

(52) U.S. Cl. CPC G01M 11/0207

(57) ABSTRACT

Described herein is a reflective mount made from a single continuous material, featuring a reflective pane connected to at least one mounting surface. The reflective pane can be positioned at an angle of 30° to 60° relative to the mounting surface and may include an angling bridge oriented between 0° and 90° to the mounting surface. The design can incorporate one or more raised panes protruding from the reflective pane, each positioned at an angle of 10° to 50° relative to the reflective pane. A reflective material may be affixed to the reflective pane alone, to each raised pane, or to both the reflective and raised panes. This reflective mount can be incorporated into a verification system.

### CROSS-REFERENCE TO RELATED APPLICATIONS

This application claims the benefit under 35 U.S.C. § 119 (e) of U.S. Provisional Application No. 63/568,225 filed on Mar. 21, 2024, the disclosure (text, drawings, and claims) of which is incorporated herein by reference in its entirety.

### BACKGROUND OF THE DISCLOSURE

Vehicle operators, particularly those operating larger vehicles such as trucks, especially over-the-road trucks for long-distance hauling, sport utility vehicles, and vans, regularly need to verify that all exterior lights and similar fixtures are functioning properly. This verification is crucial for both safety and regulatory compliance. Various state and federal regulations require all vehicle lighting systems, including headlights, taillights, brake lights, turn signals, and hazard lights, to be in proper working order at all times. Insurance companies depend upon safe drivers and save vehicles for calculating risks. Failure to maintain functional lighting systems may result in traffic citations, increased likelihood of accidents, potential liability issues, and dangerous traffic mishaps that could have been avoided.

Traditional methods for verifying light functionality involve several cumbersome approaches. A common method requires the vehicle operator to exit the vehicle, activate the desired light function (often by using objects to depress the brake pedal or by enlisting assistance from another individual), walk around the vehicle to visually inspect each light, and then return to the driver's seat. This process is time-consuming, physically demanding for some individuals, and often impractical in adverse weather conditions. For commercial drivers who must verify light functionality as part of their pre-trip inspection routine, this traditional approach adds significant time to their departure preparations.

Alternative solutions such as electronic monitoring systems exist but present their own limitations. These systems typically rely on electrical current sensors that detect whether electricity is flowing to the light fixture but cannot confirm if the light is actually illuminating or if the lens cover is intact. Moreover, such systems add cost and complexity to vehicle maintenance and are not universally available for all vehicle types or model years.

Consequently, there exists a need for a simple, cost-effective, universally available, and reliable system that enables vehicle operators to verify the functionality of all exterior lighting systems without requiring the operator to exit the vehicle or depend on specialized electronic equipment.

### BRIEF SUMMARY

Described herein is a reflective mount made from a single continuous material, featuring a reflective pane connected to at least one mounting surface. The reflective pane can be positioned at an angle of 30° to 60° relative to the mounting surface and may include an angling bridge oriented between 0° and 90° to the mounting surface. The design can incorporate one or more raised panes protruding from the reflective pane, each positioned at an angle of 10° to 50° relative to the reflective pane. A reflective material may be affixed to the reflective pane alone, to each raised pane, or to both the reflective and raised panes. This reflective mount can be incorporated into a verification system.

### BRIEF DESCRIPTION OF THE FIGURES

FIG. 1 provides an exemplary perspective view of a reflective mount in accordance with various embodiments of the present disclosure.

FIG. 2 provides an exemplary top view of a reflective mount in accordance with various embodiments of the present disclosure.

FIG. 3 provides an exemplary rear elevation view of a reflective mount in accordance with various embodiments of the present disclosure.

FIG. 4 provides an exemplary side elevation view of a reflective mount in accordance with various embodiments of the present disclosure.

FIG. 5 provides an exemplary perspective view of a reflective mount in accordance with various embodiments of the present disclosure.

FIG. 6 provides an exemplary top view of a reflective mount in accordance with various embodiments of the present disclosure.

FIG. 7 provides an exemplary rear elevation view of a reflective mount in accordance with various embodiments of the present disclosure.

FIG. 8 provides an exemplary side elevation view of a reflective mount in accordance with various embodiments of the present disclosure.

FIG. 9 provides an exemplary perspective view of a reflective mount in accordance with various embodiments of the present disclosure.

FIG. 10 provides an exemplary top view of a reflective mount in accordance with various embodiments of the present disclosure.

FIG. 11 provides an exemplary rear elevation view of a reflective mount in accordance with various embodiments of the present disclosure.

FIG. 12 provides an exemplary side elevation view of a reflective mount in accordance with various embodiments of the present disclosure.

FIG. 13 provides an exemplary perspective view of a reflective mount in accordance with various embodiments of the present disclosure.

FIG. 14 provides an exemplary top view of a reflective mount in accordance with various embodiments of the present disclosure.

FIG. 15 provides an exemplary rear elevation view of a reflective mount in accordance with various embodiments of the present disclosure.

FIG. 16 provides an exemplary side elevation view of a reflective mount in accordance with various embodiments of the present disclosure.

FIG. 17 provides an exemplary diagram of a vehicle in a parking area in which reflective mounts are positioned in accordance with various embodiments of the present disclosure.

### DETAILED DESCRIPTION

The following detailed description illustrates the claimed device and system by way of example and not by way of limitation. This description will clearly enable one skilled in the art to make and use the claimed device and system, and describes several embodiments, adaptations, variations, alternatives and uses of the claimed device and system, including what we presently believe is the best mode of carrying out the claimed device and system. Additionally, it is to be understood that the claimed device and system is not limited in its application to the details of construction and the arrangements of components set forth in the following description or illustrated in the drawings. The claimed device and system is capable of other embodiments and of being practiced or being carried out in various ways. Also, it is to be understood that the phraseology and terminology used herein is for the purpose of description and should not be regarded as limiting.

The present description relates to a vehicle fixture verification system utilizing strategically positioned, specially designed reflective mounts in a parking area. The system enables a vehicle operator to remain seated in a driver's position while visually confirming one or more operational statuses of a plurality of exterior vehicle fixtures.

The reflective verification system described herein comprises one or more reflective mounts positioned at predetermined locations within a parking area. The parking area may be a residential garage, commercial parking structure, fleet maintenance facility, loading dock, auto repair shop, or any other location where vehicles are regularly parked and inspected. The reflective mounts are arranged to provide the vehicle operator with visual access to the plurality of exterior vehicle fixtures, which can be otherwise difficult-to-view portions of the vehicle, particularly when located on the rear and sides of the vehicle. The plurality of vehicle fixtures can comprise lights, cameras, sensors, reflective materials, or any other vehicle fixture known to one of ordinary skill in the art.

Each reflective mount in the plurality of reflective mounts comprises a highly polished material capable of producing a clear reflection visible at a distance. The material may be selected from a group including but not limited to polished aluminum, polished stainless steel, mirrored glass with protective backing, or any other material known to one of ordinary skill in the art to comprise sufficient reflective properties. The materials and their specific geometric arrangements may be varied so long as they retain the necessary features such as maximizing sightline alignment, durability, and flexibility. To maximize sightline alignment, the reflective mounts may include complex shaping such as curved, concave, or convex configurations designed to optimize the reflection angle for specific vehicle types and parking positions. The reflective material is selected to resist environmental factors common to parking areas, including moisture, temperature fluctuations, dust accumulation, and incidental contact.

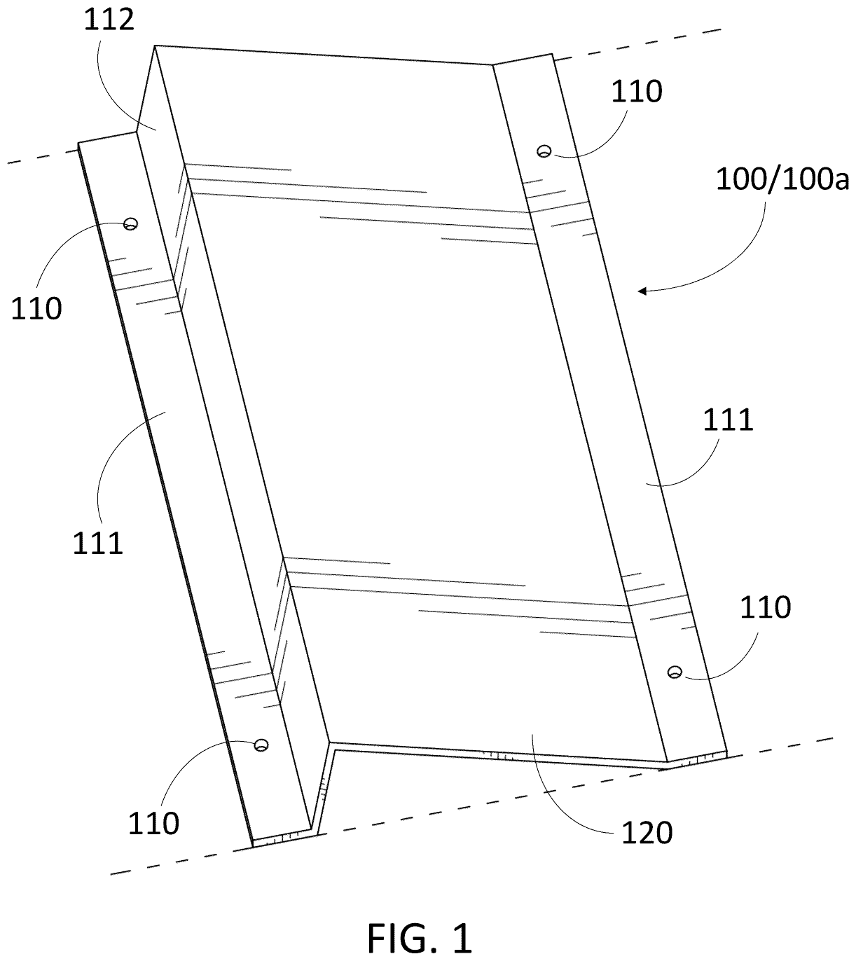

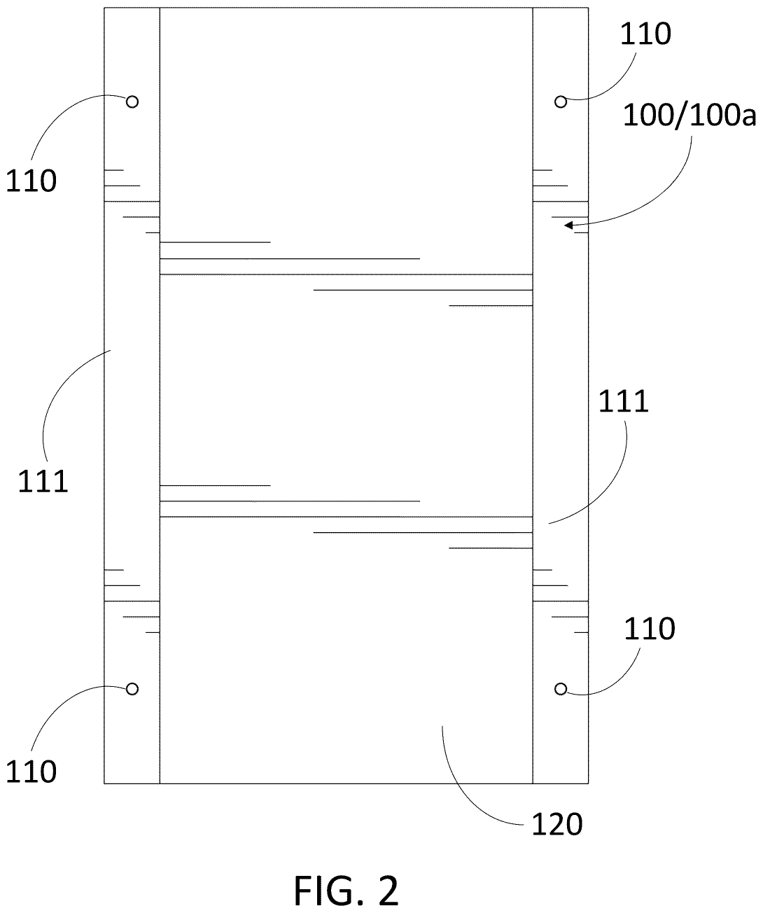

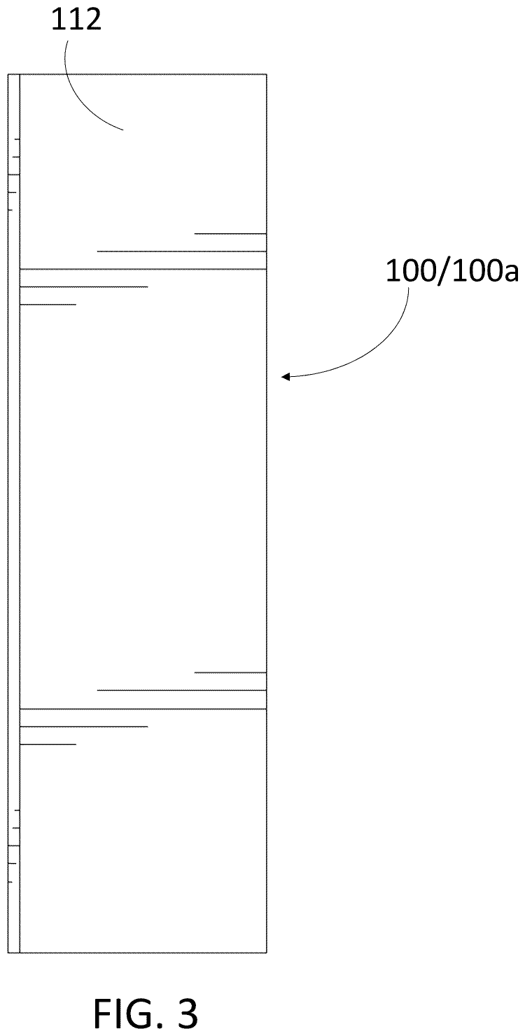

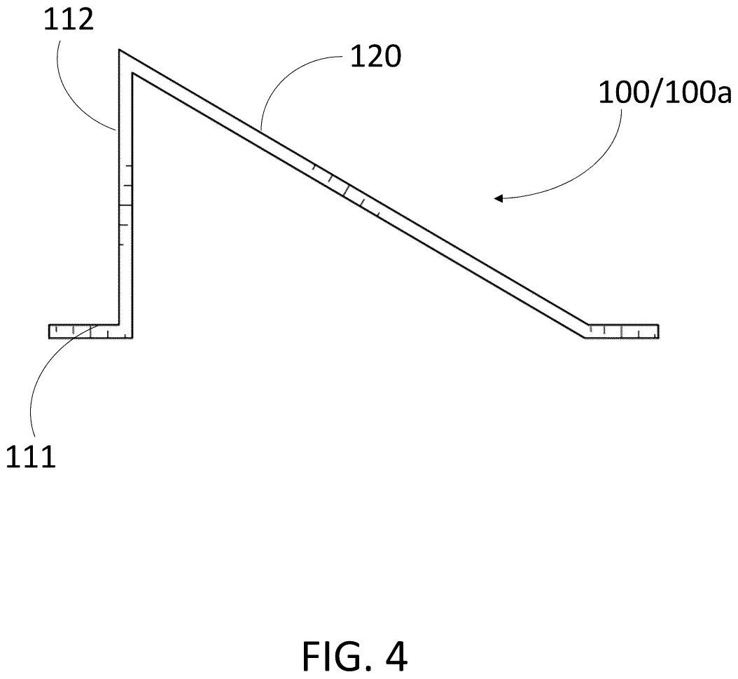

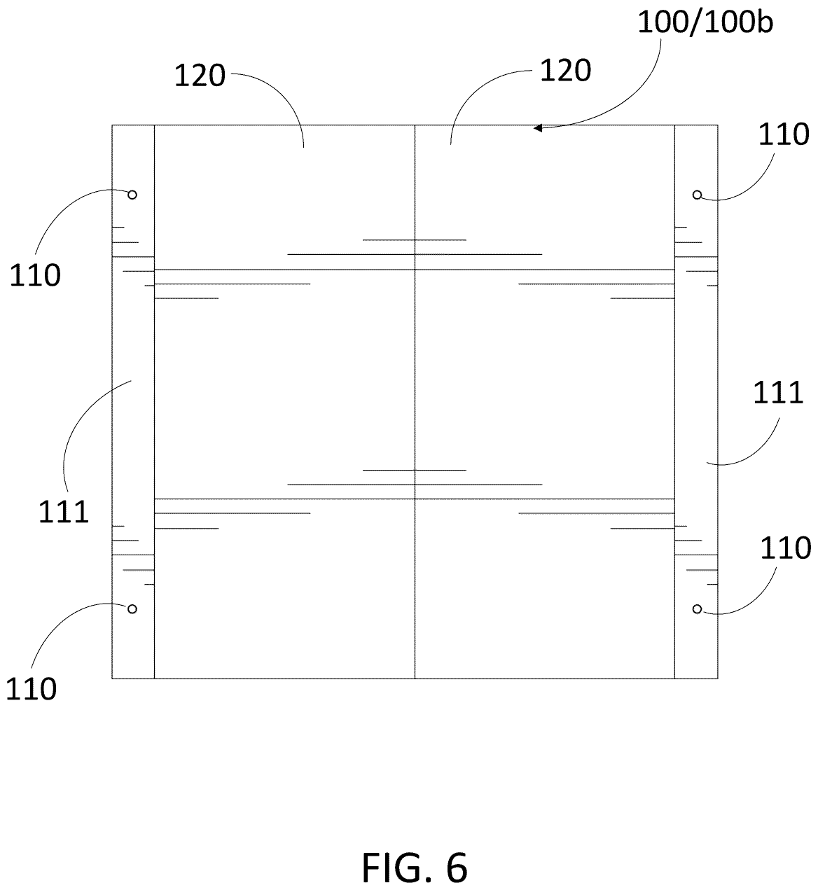

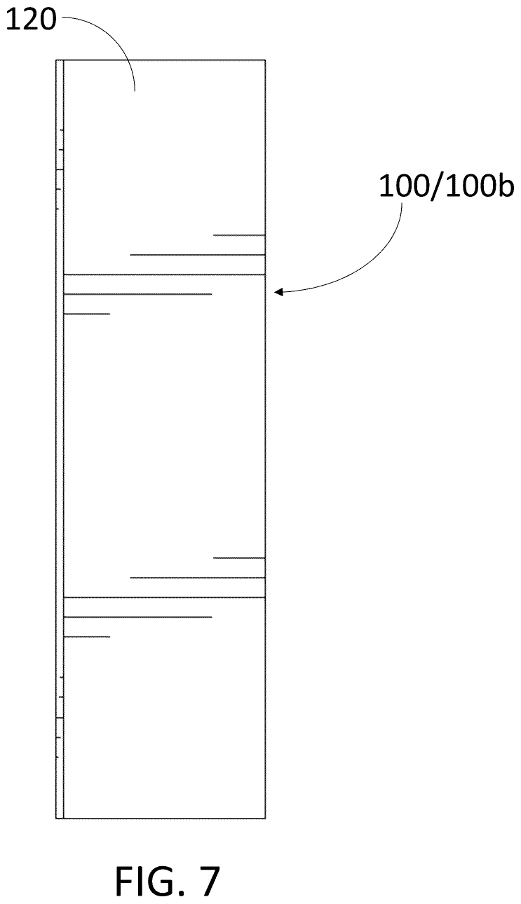

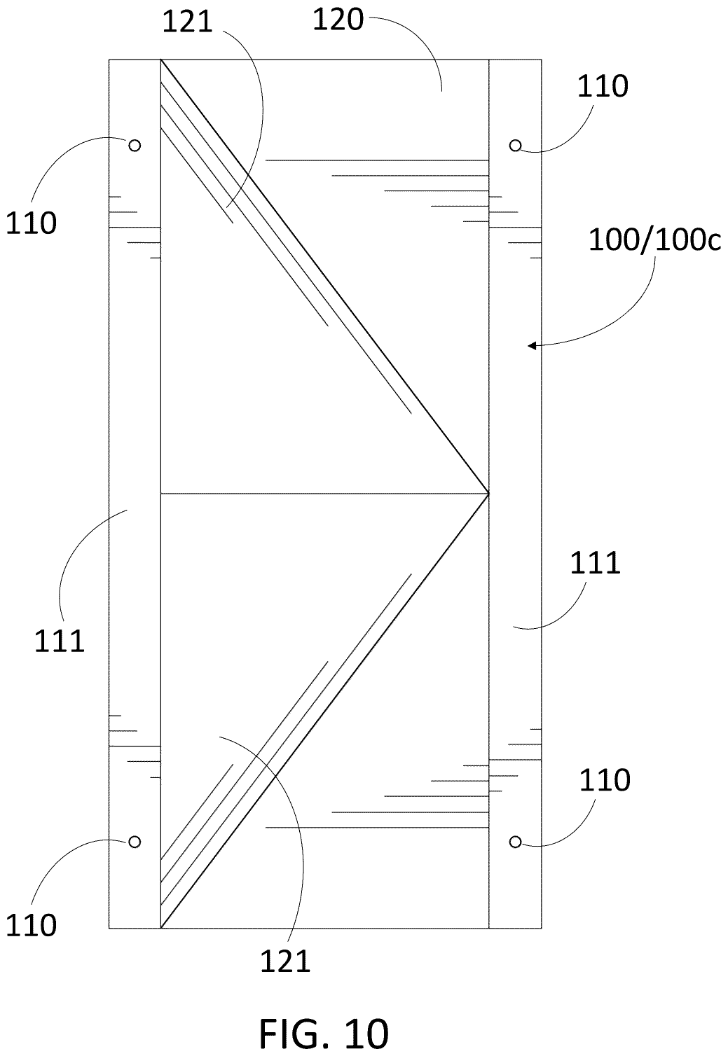

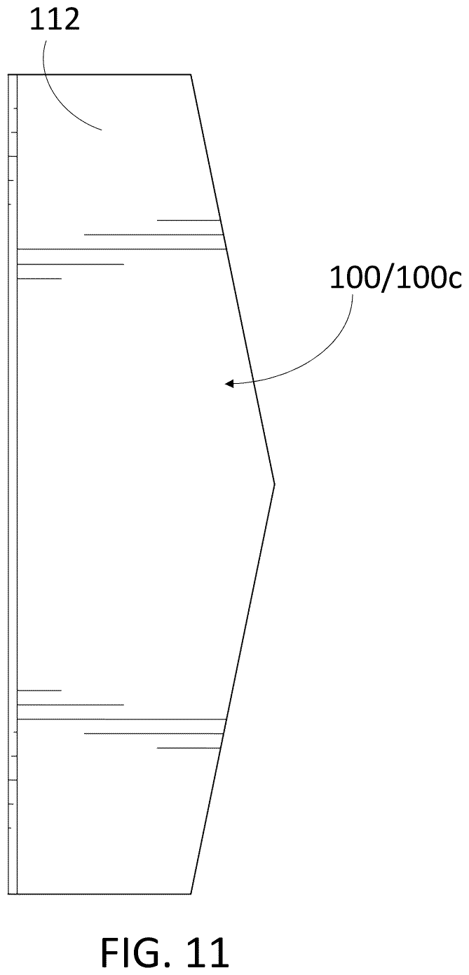

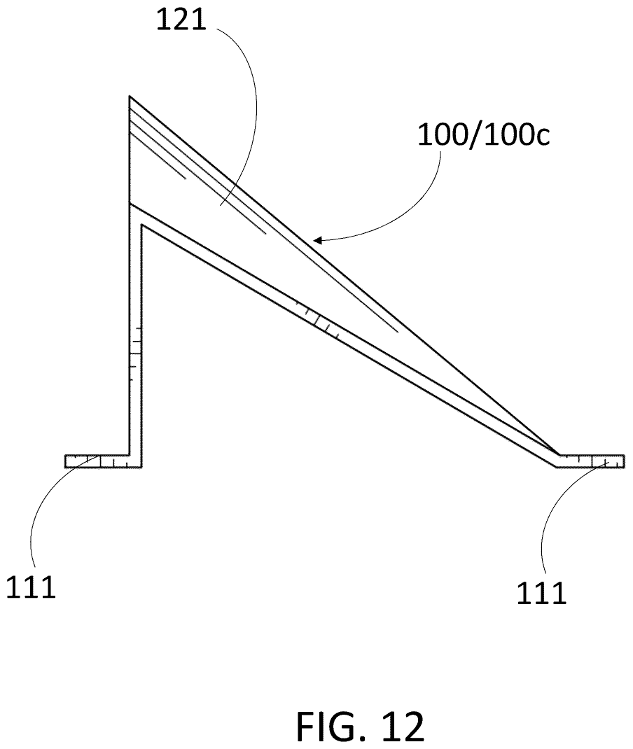

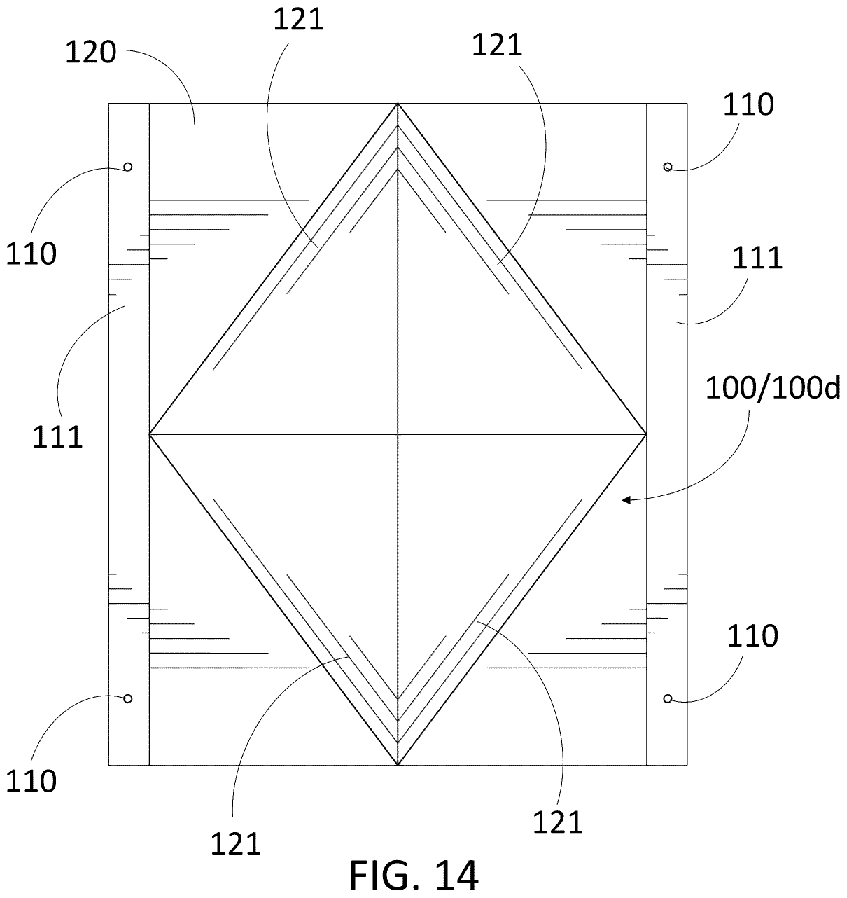

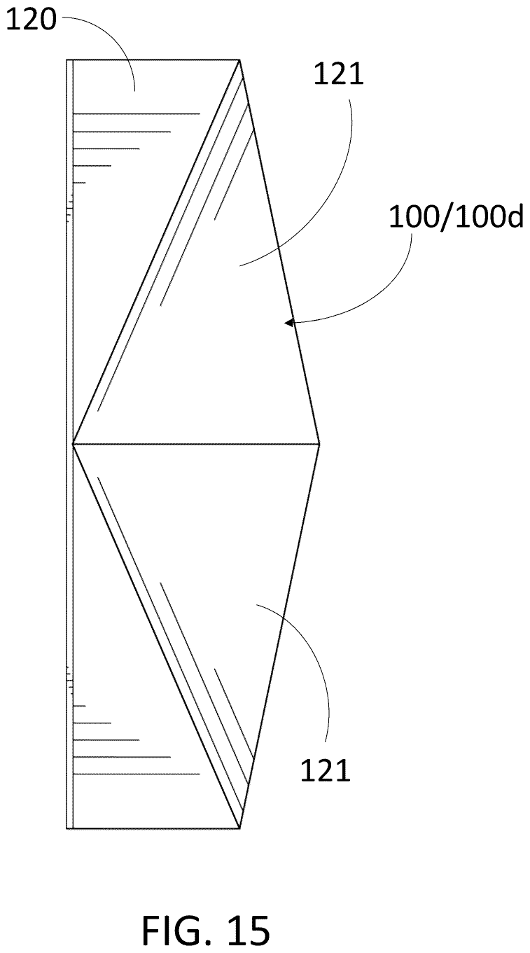

FIGS. 1-16 illustrate reflective mounts 100/100a, 100/100b, 100/100c, 100/100d in a variety of embodiments according to the present description. The reflective mounts 100/100a, 100/100b, 100/100c, 100/100d all comprise one or more holes 110 and at least one reflective pane 120. The at least one reflective pane is sufficiently polished and reflective to function as a mirror and thereby provide a reliable reflected image to an observer observing at a useful, reasonable distance.

The one or more holes 110 are each sized and disposed to receive a screw, nail, bolt, or other affixation means known to one of ordinary skill in the art. Thus, the reflective mounts 100/100a, 100/100b, 100/100c, 100/100d can each be affixed to a structural element in the parking area with the aid of the one or more holes 110. The structural element can without limitation include walls, columns, floors, ceiling components, loading docks, or other structural elements known to one of ordinary skill in the art.

The affixation means can include mating screw and bolt attachments, hinges, and any other means known to one of ordinary skill, including vacuum suction attachments for smooth, non-porous surfaces, allowing for temporary installation or repositioning without permanent modification to the structural element. Additionally, the affixation means can include brackets, adhesive mounts, hook-and-loop fasteners, adjustable arms, hinges, socket joints, and/or any other means known to one of ordinary skill in the art for ease of adjusting the height, relative positioning, and/or angle of each of the reflective mounts 100/100a, 100/100b, 100/100c, 100/100d.

FIGS. 1-4 show an exemplary embodiment of the reflective mounts 100/100a that are a single continuous material, bent at various points, that comprises one reflective pane 120, an angling bridge 112, and at least one mounting surfaces 111 that comprise the one or more holes 110. The at least one mounting surfaces 111 are planar rectangular sections sized, shaped and disposed to be pressed flush against a structural element. The angling bridge 112 is a planar section oriented at an angle between 0° and 90° with respect to the at least one mounting surfaces 111. The angling bridge 112 can be oriented at an angle between 10° and 80°, between 20° and 70°, between 30° and 60°, or between 40° and 50° with respect to the at least one mounting surfaces 111. In various exemplary embodiments, the angling bridge 112 can be oriented at an angle of 0°, 1°, 2°, 3°, 4°, 5°, 6°, 7°, 8°, 9°, 10°, 11°, 12°, 13°, 14°, 15°, 16°, 17°, 18°, 19°, 20°, 21°, 22°, 23°, 24°, 25°, 26°, 27°, 28°, 29°, 30°, 31°, 32°, 33°, 34°, 35°, 36°, 37°, 38°, 39°, 40°, 41°, 42°, 43°, 44°, 45°, 46°, 47°, 48°, 49°, 50°, 51°, 52°, 53°, 54°, 55°, 56°, 57°, 58°, 59°, 60°, 61°, 62°, 63°, 64°, 65°, 66°, 67°, 68° 69°, 70°, 71°, 72°, 73°, 74°, 75°, 76°, 77°, 78°, 79°, 80°, 81°, 82°, 83°, 84°, 85°, 86°, 87°, 88°, 89°, or 90° with respect to the at least one mounting surfaces 111. The angling bridge 112 is positioned between at least one of the at least one mounting surfaces and the reflective pane 120. The reflective pane 120 is positioned between the angling bridge 112 and another of the at least one mounting surfaces 111 and is thus also oriented at an angle between 0° and 90° with respect to the at least one mounting surfaces 111. The reflective pane 120 can be oriented at an angle between 10° and 80°, between 20° and 70°, between 30° and 60°, or between 40° and 50° with respect to the at least one mounting surfaces 111. In various exemplary embodiments, the reflective pane 120 can be oriented at an angle of 0°, 1°, 2°, 3°, 4°, 5°, 6°, 7°, 8°, 9°, 10°, 11°, 12°, 13°, 14°, 15°, 16°, 17°, 18°, 19°, 20°, 21°, 22°, 23°, 24°, 25°, 26°, 27°, 28°, 29°, 30°, 31°, 32°, 33°, 34°, 35°, 36°, 37°, 38°, 39°, 40°, 41°, 42°, 43°, 44°, 45°, 46°, 47°, 48°, 49°, 50°, 51°, 52°, 53°, 54°, 55°, 56°, 57°, 58°, 59°, 60°, 61°, 62°, 63°, 64°, 65°, 66°, 67°, 68°, 69°, 70°, 71°, 72°, 73°, 74°, 75°, 76°, 77°, 78°, 79°, 80°, 81°, 82°, 83°, 84°, 85°, 86°, 87°, 88°, 89°, or 90° with respect to the at least one mounting surfaces 111.

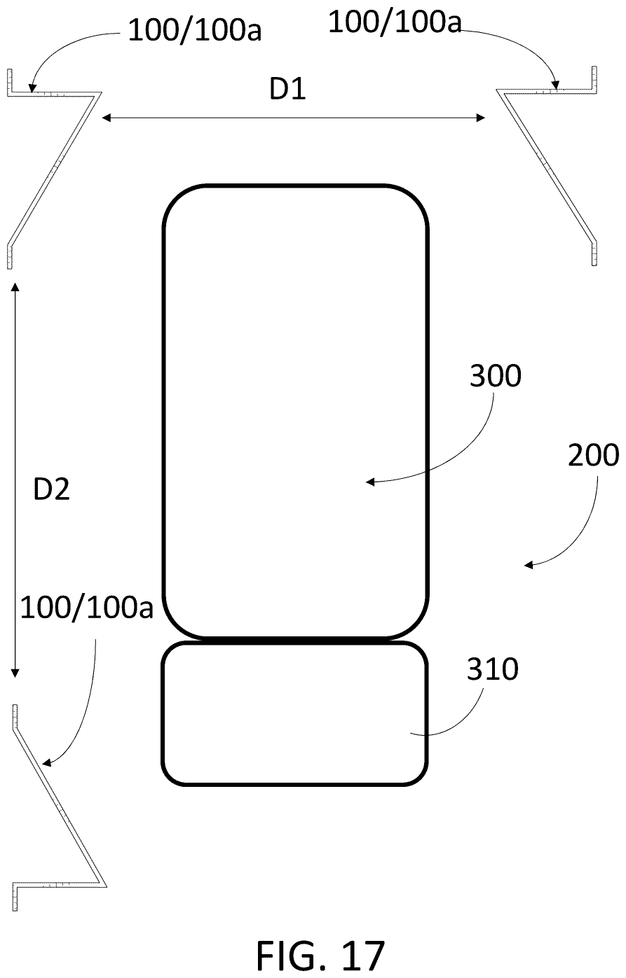

An exemplary verification system comprising the reflective mounts 100/100a in the parking area 200 with an exemplary vehicle 300 is depicted in FIG. 17. The reflective mounts 100/100a are arranged in the parking area 200 in order to maximize the ability of a driver seated in a vehicle cab 310 to easily inspect the vehicle 300 without exiting the vehicle cab 310. In various exemplary embodiments, the arrangement of the reflective mounts 100/100a is one in which multiple reflective mounts 100/100a are separated by a distance that is a function of the size of the parking area 200 and the size of the vehicle 300. In the exemplary depiction of FIG. 17, two reflective mounts 100/100a are separated by a distance D1, where the distance D1 is a function of the size of the parking area 200 and a width of the vehicle 300. Similarly, in the exemplary depiction of FIG. 17, two reflective mounts 100/100a are separated by a distance D2, where the distance D2 is a function of the size of the parking area 200 and a length of the vehicle 300.

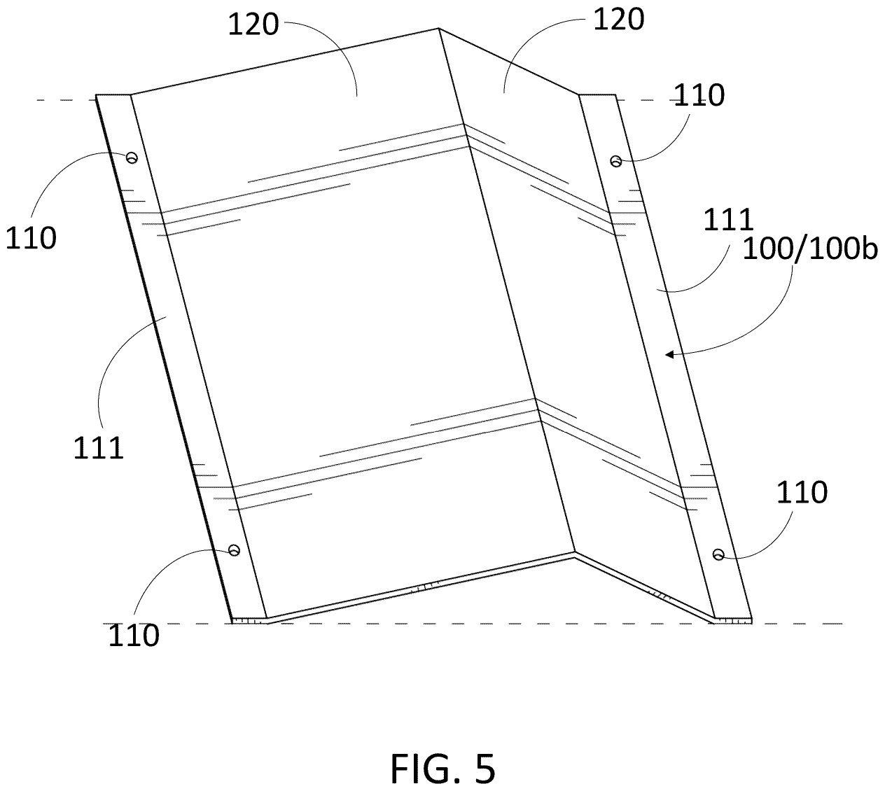

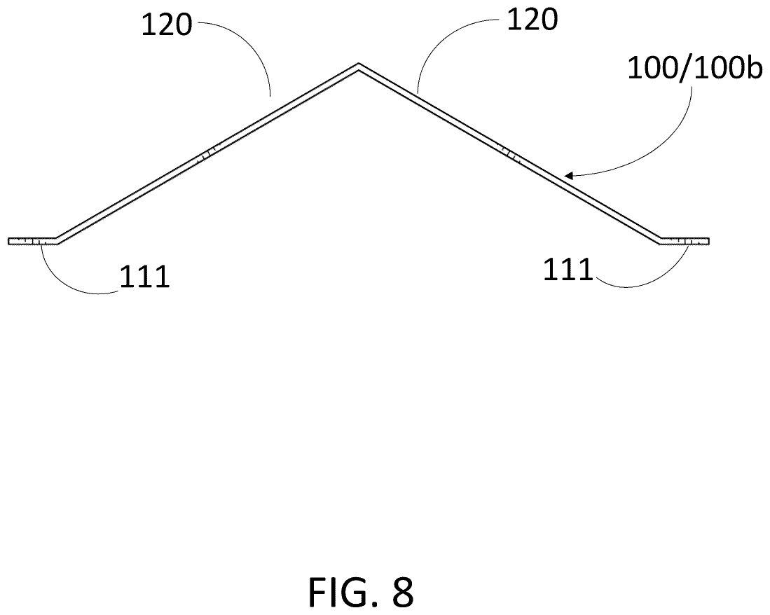

FIGS. 5-8 show an exemplary embodiment of the reflective mounts 100/100b that are a single continuous material, bent at various points, that comprises two reflective panes 120 and at least one mounting surfaces 111 that comprise the one or more holes 110. The at least one mounting surfaces 111 are planar rectangular sections sized, shaped and disposed to be pressed flush against a structural element. The two reflective panes 120 are positioned between the at least one mounting surfaces 111 and are also each oriented at an angle between 0° and 90° with respect to the at least one mounting surfaces 111. The reflective panes 120 can each be oriented at an angle between 10° and 80°, between 20° and 70°, between 30° and 60°, or between 40° and 50° with respect to the at least one mounting surfaces 111. In various exemplary embodiments, the reflective panes 120 can each be oriented at an angle of 0°, 1°, 2°, 3°, 4°, 5°, 6°, 7°, 8°, 9°, 10°, 11°, 12°, 13°, 14°, 15°, 16°, 17°, 18°, 19°, 20°, 21°, 22°, 23°, 24°, 25°, 26°, 27°, 28°, 29°, 30°, 31°, 32°, 33°, 34°, 35°, 36°, 37°, 38°, 39°, 40°, 41°, 42°, 43°, 44°, 45°, 46°, 47°, 48°, 49°, 50°, 51°, 52°, 53°, 54°, 55°, 56°, 57°, 58°, 59°, 60°, 61°, 62°, 63°, 64°, 65°, 66°, 67°, 68°, 69°, 70°, 71°, 72°, 73°, 74°, 75°, 76°, 77°, 78°, 79°, 80°, 81°, 82°, 83°, 84°, 85°, 86°, 87°, 88°, 89°, or 90° with respect to the at least one mounting surfaces 111. As particularly shown in FIG. 5 and FIG. 8, the two reflective panes are thus oriented in opposing directions, which can allow a driver to look at multiple different sections of the vehicle 300 while observing a single reflective mount 100/100b.

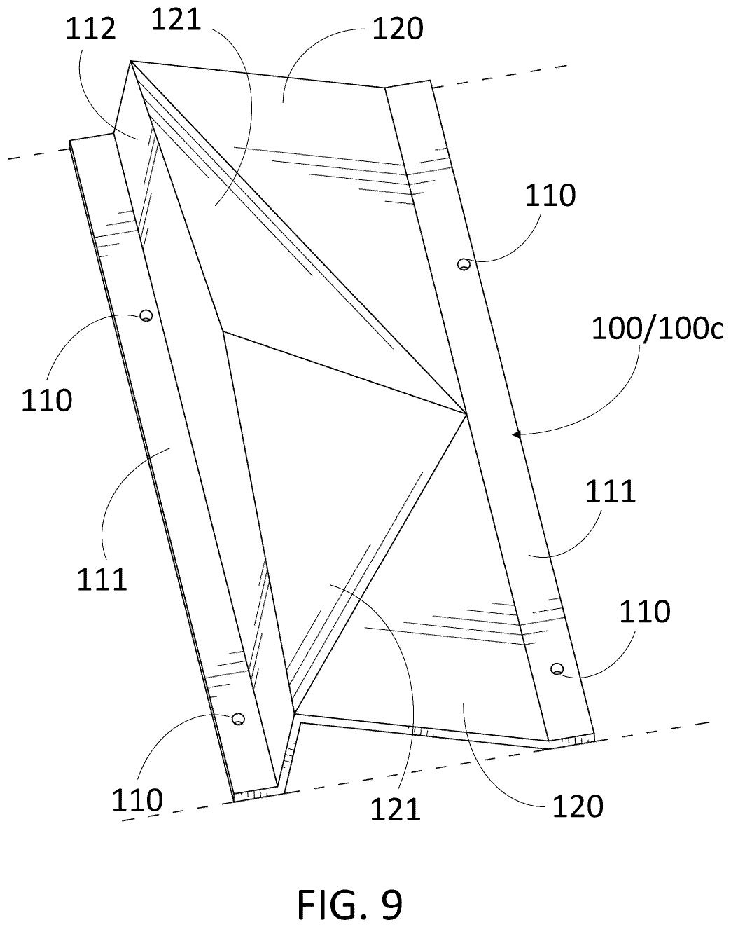

FIGS. 9-12 show an exemplary embodiment of the reflective mounts 100/100c that are a single continuous material, bent at various points, that comprises the reflective pane 120, the angling bridge 112, one or more raised panes 121, and at least one mounting surfaces 111 that comprise the one or more holes 110. The angling bridge 112 is a planar section oriented at an angle between 0° and 90° with respect to the at least one mounting surfaces 111 that is positioned between at least one of the at least one mounting surfaces and the reflective pane 120. The reflective pane 120 is positioned between the angling bridge 112 and another of the at least one mounting surfaces 111 and is thus also oriented at an angle between 0° and 90° with respect to the at least one mounting surfaces 111. The reflective pane 120 can be oriented at an angle between 10° and 80°, between 20° and 70°, between 30° and 60°, or between 40° and 50° with respect to the at least one mounting surfaces 111. In various exemplary embodiments, the reflective pane 120 can be oriented at an angle of 0°, 1°, 2°, 3°, 4°, 5°, 6°, 7°, 8°, 9°, 10°, 11°, 12°, 13°, 14°, 15°, 16°, 17°, 18°, 19°, 20°, 21°, 22°, 23°, 24°, 25°, 26°, 27°, 28°, 29°, 30°, 31°, 32°, 33°, 34°, 35°, 36°, 37°, 38°, 39°, 40°, 41°, 42°, 43°, 44°, 45°, 46°, 47°, 48°, 49°, 50°, 51°, 52°, 53°, 54°, 55°, 56°, 57°, 58°, 59°, 60°, 61°, 62°, 63°, 64°, 65°, 66°, 67°, 68°, 69°, 70°, 71°, 72°, 73°, 74°, 75°, 76°, 77° 78°, 79°, 80°, 81°, 82°, 83°, 84°, 85°, 86°, 87°, 88°, 89°, or 90° with respect to the at least one mounting surfaces 111. The reflective pane 120 further comprises one or more raised panes 121 that are made from the same material and have the same reflective finish as the reflective pane 120, and which project at an angle between 0° and 60° with respect to the reflective pane 120. The one or more raised panes 120 can each be oriented at an angle between 10° and 50°, between 20° and 40°, or between 30° and 40° with respect to the reflective pane 120. In various exemplary embodiments, each of the one or more raised panes 121 can be oriented at an angle of 0°, 1°, 2°, 3°, 4°, 5°, 6°, 7°, 8°, 9°, 10°, 11°, 12°, 13°, 14°, 15°, 16°, 17°, 18°, 19°, 20°, 21°, 22°, 23°, 24°, 25°, 26°, 27°, 28°, 29°, 30°, 31°, 32°, 33°, 34°, 35°, 36°, 37°, 38°, 39°, 40°, 41°, 42°, 43°, 44°, 45°, 46°, 47°, 48°, 49°, 50°, 51°, 52°, 53°, 54°, 55°, 56°, 57°, 58°, 59°, 60° with respect to the reflective pane 120. As seen in the exemplary embodiment depicted particularly in FIG. 9, the one or more raised panes 121 can be oriented so as to provide reflected images of higher or lower verticality with respect to the reflective pane 120. Thus, the driver can observe a single reflective mount 100/100c and receive multiple reflected images of the vehicle 300 that are angled along multiple dimensions.

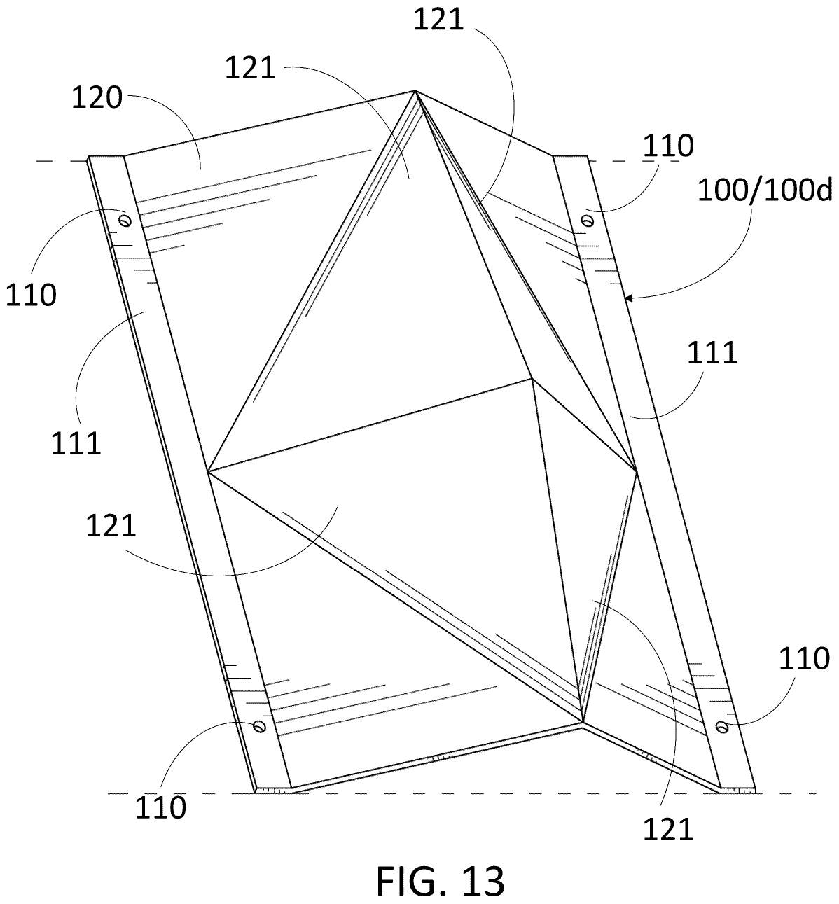

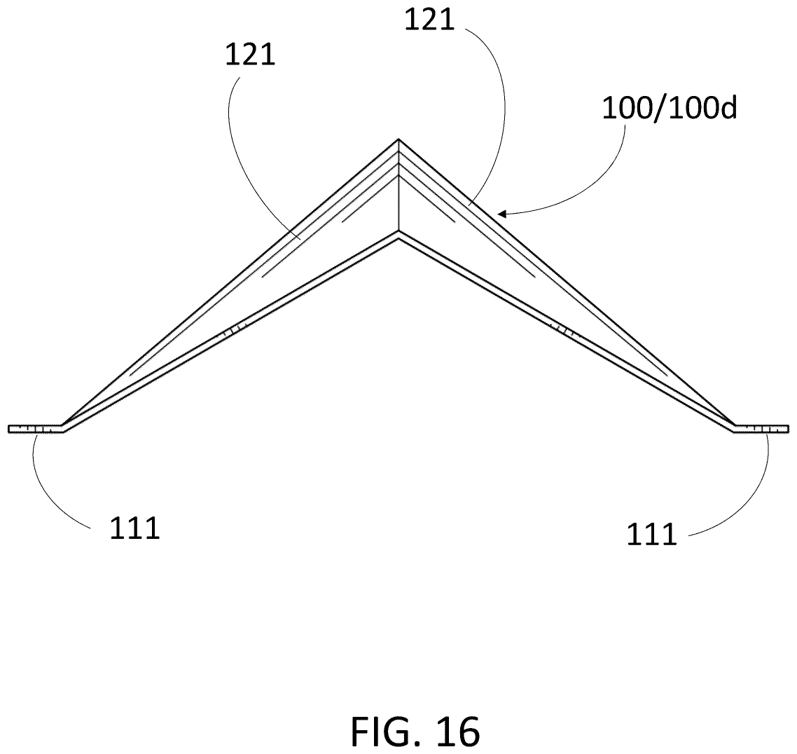

FIGS. 13-16 show an exemplary embodiment of the reflective mounts 100/100d that are a single continuous material, bent at various points, that comprises two reflective panes 120, one or more raised panes 121, and at least one mounting surfaces 111 that comprise the one or more holes 110. The two reflective panes 120 are positioned between the at least one mounting surfaces 111 and are also oriented at an angle between 0° and 90° with respect to the at least one mounting surfaces 111. The reflective panes 120 can each be oriented at an angle between 10° and 80°, between 20° and 70°, between 30° and 60°, or between 40° and 50° with respect to the at least one mounting surfaces 111. In various exemplary embodiments, the reflective panes 120 can each be oriented at an angle of 0°, 1°, 2°, 3°, 4°, 5°, 6°, 7°, 8°, 9°, 10°, 11°, 12°, 13°, 14°, 15°, 16°, 17°, 18°, 19°, 20°, 21°, 22°, 23°, 24°, 25°, 26°, 27°, 28°, 29°, 30°, 31°, 32°, 33°, 34°, 35°, 36°, 37°, 38°, 39°, 40°, 41°, 42°, 43°, 44°, 45°, 46°, 47°, 48°, 49°, 50°, 51°, 52°, 53°, 54°, 55°, 56°, 57°, 58°, 59°, 60°, 61°, 62°, 63°, 64°, 65°, 66°, 67°, 68°, 69°, 70°, 71°, 72°, 73°, 74°, 75°, 76°, 77°, 78°, 79°, 80°, 81°, 82°, 83°, 84°, 85°, 86°, 87°, 88°, 89°, or 90° with respect to the at least one mounting surfaces 111. As particularly shown in FIG. 13 and FIG. 16, the two reflective panes are thus oriented in opposing directions, which can allow a driver to look at multiple different sections of the vehicle 300 while observing a single reflective mount 100/100d. The reflective panes 120 each further comprise one or more raised panes 121 that are made from the same material and have the same reflective finish as the reflective pane 120, and which project at an angle between 0° and 60° with respect to each reflective pane 120. The one or more raised panes 120 can each be oriented at an angle between 10° and 50°, between 20° and 40°, or between 30° and 40° with respect to the reflective pane 120. In various exemplary embodiments, each of the one or more raised panes 121 can be oriented at an angle of 0°, 1°, 2°, 3°, 4°, 5°, 6°, 7°, 8°, 9°, 10°, 11°, 12°, 13°, 14°, 15°, 16°, 17°, 18°, 19°, 20°, 21°, 22°, 23°, 24°, 25°, 26°, 27°, 28°, 29°, 30°, 31°, 32°, 33°, 34°, 35°, 36°, 37°, 38°, 39°, 40°, 41°, 42°, 43°, 44°, 45°, 46°, 47°, 48°, 49°, 50°, 51°, 52°, 53°, 54°, 55°, 56°, 57°, 58°, 59°, 60° with respect to the reflective pane 120. As seen in the exemplary embodiment depicted particularly in FIG. 13, the one or more raised panes 121 can be oriented so as to provide reflected images of higher or lower verticality with respect to each reflective pane 120. Thus, the driver can observe a single reflective mount 100/100d and receive multiple reflected images of the vehicle 300 that are angled along multiple dimensions.

Variations and alternative embodiments readily envisioned by one of ordinary skill are considered to be within the scope of the present description. The materials used for the reflective mounts 100 are selected for durability and longevity in parking area conditions. Such materials include those that resist scratching, corrosion, and degradation from environmental factors including temperature fluctuations, humidity, and exposure to automotive fluids or exhaust, including but not limited to aluminum and stainless steel. The size and dimensions of each reflective mount 100 are determined based on the viewing distance, required coverage area, and spatial constraints of the parking area 200.

In various exemplary embodiments, the reflective mount 100 itself can be made of a non-reflective material such as most plastics. In such embodiments, the reflective mount can be affixed with a reflective material, such as reflective polymer, silvered glass, or any other material known to one of ordinary skill in the art to reflect light as a mirror does. The reflective material can be affixed to each reflective pane 120 and/or to each raised pane 121. The reflective mount 100 can thereby retain its ability to provide reflected images to a driver while being constructed from less expensive and/or lighter-weight materials.

In various exemplary embodiments, a proximity detection system can be integrated with the reflective mounts to enhance functionality and prevent damage to the vehicle 300 or the reflective mounts 100. In various exemplary embodiments, the proximity detection system comprises a distance tracking sensor mounted on or near the reflective mount 100. When the vehicle 300 reaches an appropriate distance from the reflective mount 100, an indication such as a sound, a light, or any other indication known to one of ordinary skill can be sent to the driver to alert them that the vehicle 300 is properly positioned and oriented with respect to the reflective mount 100.

In operation, the vehicle 300 enters the parking area 200 and is positioned at a predetermined stopping point. The predetermined stopping point can be marked on the parking area 200 or indicated by a physical stop such as a parking block or the proximity detection system. When the vehicle 300 is correctly positioned, the driver remains in the vehicle cab 310 and activates the vehicle's various lighting systems sequentially. The operator observes the reflections in the strategically positioned reflective mounts 100 to verify that all lighting systems, reflective patches, and other vehicle fixtures are mounted, displayed, and/or functioning properly.

As various changes could be made in the above constructions without departing from the scope of the claimed device and system, it is intended that all matter contained in the above description or shown in the accompanying drawings shall be interpreted as illustrative and not in a limiting sense.

What is claimed is:

1. A reflective mount that is formed of a single continuous material comprising a reflective pane adjacent to at least one mounting surface.

2. The reflective mount of claim 1 wherein the reflective pane is oriented at an angle between 30° and 60° with respect to the at least one mounting surface.

3. The reflective mount of claim 1 further comprising an angling bridge.

4. The reflective mount of claim 3 wherein the angling bridge is oriented at an angle between 0° and 90° with respect to the at least one mounting surface.

5. The reflective mount of claim 1 further comprising one or more raised panes protruding from the reflective pane.

6. The reflective mount of claim 5 wherein each of the one or more raised panes is oriented at an angle between 10° and 50° with respect to the reflective pane.

7. The reflective mount of claim 1 wherein a reflective material is affixed to the reflective pane.

8. The reflective mount of claim 5 wherein a reflective material is affixed to one of:
the reflective pane;
each of the one or more raised panes; or
both the reflective pane and each of the one or more raise panes.

9. A verification system comprising one or more reflective mounts according to claim 1.
